(19) United States
(12) Patent Application Publication
(10) Pub. No.: US 2011/0004528 A1
(43) Pub. Date: Jan. 6, 2011

(54) REFUND SYSTEM AND METHOD

(76) Inventors: Anthony Donohue, Singapore (SG); Gareth Lewis, New South Wales (AU)

Correspondence Address: MEYERTONS, HOOD, KIVLIN, KOWERT & GOETZEL, P.C., P.O. BOX 398, AUSTIN, TX, 78767-0398, US

(21) Appl. No.: 12/920,881

(22) PCT Filed: Mar. 6, 2009
(86) PCT No.: PCT/EP09/01624

§ 371 Date: Sep. 3, 2010

(30) Foreign Application Priority Data
Mar. 10, 2008 (GB) 0804412.5

(51) Int. Cl. G06Q 20/00

(52) U.S. Cl. 705/19

(57) ABSTRACT

A payment terminal system for a card-based purchase can automatically determine a purchase that is potentially entitled to a tax refund from a billing currency for the payment card indicated in a purchase approval response message in response to payment authorisation request transmitted by the payment terminal system. Tax refund records are allocated. The tax refund records make reference to one or more reference currencies.

### BACKGROUND

The present invention relates to card-based payment system and method, and in particular to a payment terminal system that provides for the generation of forms to facilitate, for example, tax refunds associated with purchases. The tax refund could be associated with, for example, a value added tax (VAT), a general sales tax (GST), a purchase tax (PT) or the like.

A typical retail establishment will process a large number of transactions during a trading period. There is a need to process transactions as efficiently as possible to avoid delays in handling customer purchases.

Many countries allow tax free shopping for tourists. In order to allow tax free shopping, various requirements have to be met, including the preparation of a tax refund form for a purchase, that include various details including details of the payment card holder and the purchase. Preferably, such forms are only prepared where the purchaser is likely to be entitled to a tax refund. It would be possible for each purchase, for a retailer to ask purchasers whether they wish a tax refund form to be prepared. However, it would be desirable to avoid having to ask all purchasers as to whether they wish a tax refund form to be prepared.

Accordingly, there is a need automatically to identify purchases for which a tax refund form may be appropriate to reduce the number of customers that want a tax refund form to be prepared.

### SUMMARY

A payment terminal system can include one or more devices for the input of payment card and purchase details. One or more communication interfaces can be provided for transmitting input payment card details to a remote external system for payment approval and for receiving a response message from the remote external system. One or more processing engines can be operable to identify a currency associated with the payment card and/or a home country of the payment card holder from the response message and, where the currency associated with the payment card differs from one or more reference currencies recorded for the payment terminal system and/or where the home country of the card holder is outside a tax zone for the payment terminal system, to offer a tax refund record for the purchase. The tax refund can be associated with a sales tax such as, for example a value added tax (VAT), a general sales tax (GST), etc.

A currency associated with the payment card can be identified, for example, from a billing currency code in the response message. The billing currency code can be code identified in the response message from the card issuer or the respective card payment operator's processing system, to identify the currency in which the card holder is billed. One or more reference billing codes can be stored, for example in the payment terminal, or a tax refund host system or in an acquirer bank system.

Using a currency associated with the payment card that is identified from the response message, and comparing this to one or more a reference currencies recorded for the payment terminal system, the payment terminal system can make a determination automatically as to whether the purchaser is likely to be a local or a tourist, and in the latter case to be able automatically to offer a tax refund form for a purchase that is to be exported.

A tax refund system can include one or more such payment terminal systems and a remote management system for storing tax refund records.

A method of automatically determining purchases potentially entitled to a tax refund can include receiving input of payment card and purchase details; transmitting input payment card details to a remote external system for payment approval; receiving a response message from the remote external system; determining a currency associated with the for the payment card or a country of origin of the card holder from the response message; and where the currency associated with the payment card (or the home country of the payment card holder) differs from the reference currency or currencies recorded for the payment terminal system, or the country of the payment terminal system, to offer a tax refund record for the purchase.

Although various aspects of the invention are set out in the accompanying claims, other aspects of the invention include any combination of features from the described embodiments and/or the accompanying dependent claims with the features of the independent claims, and not solely the combinations explicitly set out in the accompanying claims.

### BRIEF DESCRIPTION OF THE DRAWINGS

Embodiments are described, by way of example only, with reference to the accompany drawings.

FIG. 1 is a schematic block diagram illustrating an example of a card payment system.

FIG. 2 is a block diagram illustrating an example of a payment terminal system.

FIG. 3 is a block diagram illustrating an example of a tax refund system.

FIG. 4 is a transaction flow diagram illustrating the operation of an example of the generation of a tax refund record in response to a card-based purchase.

### DETAILED DESCRIPTION

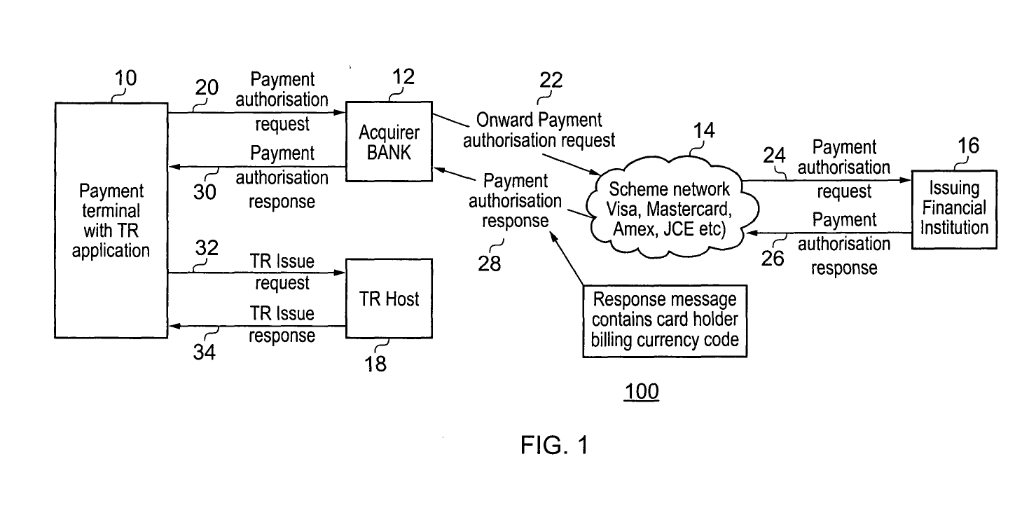

FIG. 1 is a schematic block diagram illustrating an example of a payment card system 100.

FIG. 1 illustrates a payment terminal system 10 that includes card payment functionality and additionally includes tax refund system functionality. The payment terminal system 10 can be configured as a point of sale terminal located, for example, in the premises of a retailer. The payment card can, for example, be a credit or debit card, or another form card that can be used to effect a payment.

The payment terminal system 10 can include one or more interfaces for receiving card payment and purchase details. The payment terminal system 10 is in communication via a communications network (for example via the Internet, a telephone network or another network) with a computer system 12 of a bank that provides banking services for retailer, hereinafter referred to as an acquirer bank system 12. As a part of processing a card payment, the payment terminal system 10 generates a payment authorisation request message 20 that is transmitted to the acquirer bank system 12.

The acquirer bank system 12 can include one or more computers. The acquirer bank system 12 can be operable to receive a payment authorisation request message 20 from the payment terminal system 10 and to return an authorisation response message 30 in due course to the payment terminal system 10. The acquirer bank system 12 is further in communication via a communications network (for example via the Internet, a telephone network or another network) with a network 14 of computer systems of a payment card operator (hereinafter referred to as the scheme network system 14). Although only one scheme network system 14 is shown in FIG. 1, the acquirer bank system 12 will be in communication with respective scheme network systems for respective payment card operators. The acquirer bank system 12 is operable to analyse a payment authorisation request message 20 received from the payment terminal system 10 to determine an appropriate scheme network system for the card concerned and to forward a payment authorisation request message 22 to the appropriate scheme network system 14.

The scheme network system 14 can be operable to receive the payment authorisation request message 22 from the acquirer bank system 12 and to return an authorisation response message 28 in due course to the acquirer bank system 12. The scheme network system 14 is further in communication via a communications network (for example via the Internet, a telephone network or another network) with a computer system 16 of a financial institution that issued the payment card (hereinafter referred to as the issuing financial institution system). Although only one issuing financial institution system 16 is shown in FIG. 1, the scheme network system 14 will be in communication with respective issuing financial institution systems 16 for respective issuing financial institutions.

The scheme network system 14 can be operable to analyse the received payment authorisation request message 22 to identify the issuing financial institution that issued the payment card. The scheme network system 14 can then be operable to forward a payment authorisation request message 24 to the issuing financial institution system 16 concerned, and to receive a response message 26 from the issuing financial institution system 16.

The issuing financial institution system 16 can be operable to receive the payment authorisation request message 24, to process the authorisation request by comparing the details of the payment request to records held for the payment card concerned, and then to transmit an appropriate authorisation response message 26 to the scheme network system 14. The authorisation response message 26 includes various details including a code defining a billing currency for the payment card. The authorisation response message 26 is then forwarded via the scheme network system 14, the acquirer bank system 12 to the payment terminal system 10.

FIG. 1 also illustrates a tax refund system 18 of a tax refund system operator. The tax refund system 18 can include one or more computers for processing a tax refunds. The tax refunds can relate, for example to a refund of a tax associated with a purchase such as, for example a value added tax (VAT), a general sales tax (GST), or the like.

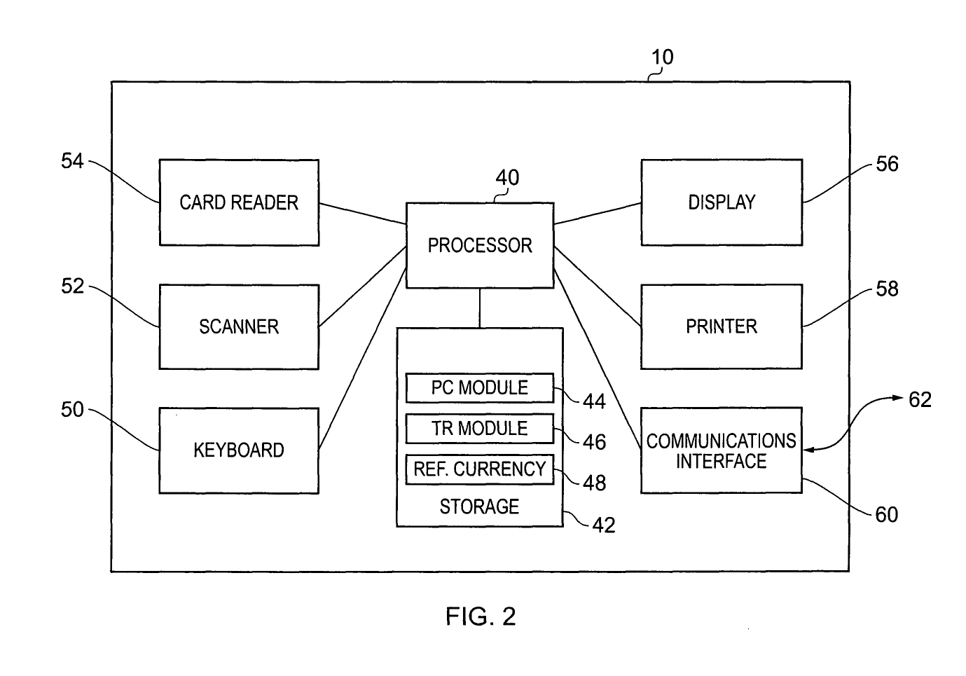

FIG. 2 is a schematic block diagram of an example of a payment terminal system 10. The example payment terminal system 10 illustrated in FIG. 2 includes one or more processors 40, storage 42 (which can include volatile and non-volatile memory), for the storage of programs and data. FIG. 2 illustrates that the storage 42 includes a card processing application forming a card processing application module 44, a tax refund application forming a tax refund module 46 and reference currency information 48. It should be noted that the storage 42 can contain other applications and data.

FIG. 2 also represents, schematically, a keyboard/keypad 50, a scanner 52 and a card reader 54. The keyboard/keypad 50 can be keyboard with separate keys, or can be configured as a touch screen keyboard/keypad and can be used for the input of numerical and/or other characters as appropriate. The scanner 52 can, for example be a bar code scanner, an RFI tag scanner or the like. The card reader 54 can be configured to read data from a payment card. The card reader 54 can be a magnetic stripe reader, a chip card reader, an RFI tag reader, etc., as appropriate. Also, where appropriate, the card reader 54 can also be operable to write information to a suitably configured payment card.

FIG. 2 further represents, schematically, a display 56, a printer 58 and a communication interface 62. The display 56 can be a numeric display, an alphanumeric display, an image display, etc., as appropriate to display input data and/or messages to assist the user and/or a retailer in operation of the payment terminal system 10. The printer 58 can be used for printing purchase receipts and/or tax refund forms or cheques and/or other information. The communications interface 60 enables communications via one or more communications channels 62 from the payment terminal system 10 to the acquirer bank system 12 and to the tax refund system 18, either directly or via a retailer computer network (not shown).

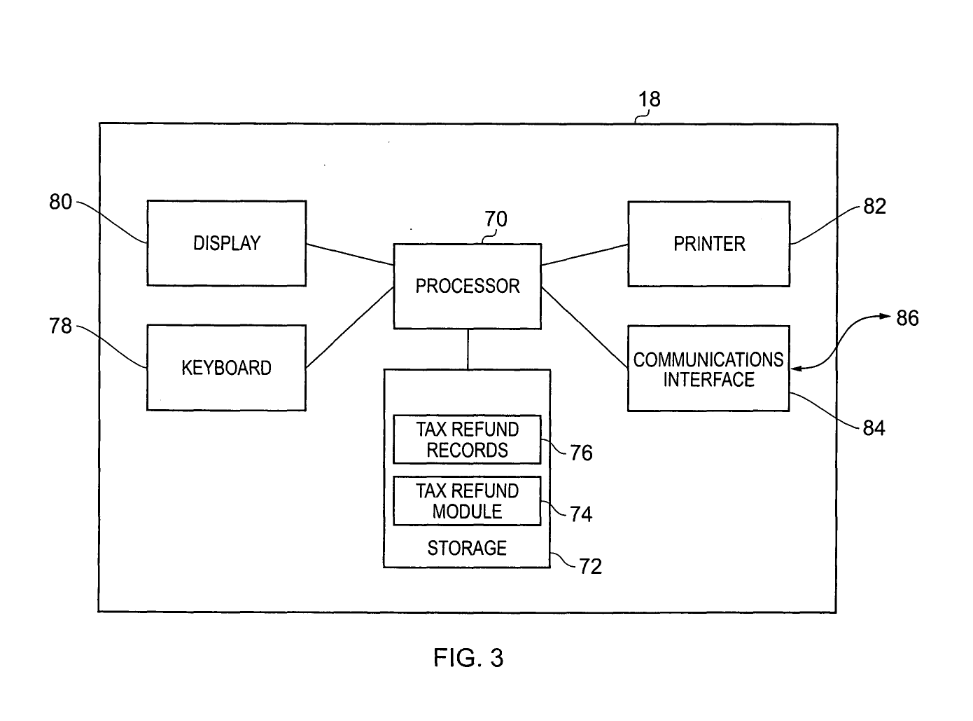

FIG. 3 is a schematic block diagram of an example of a tax refund system 18. The example tax refund system 18 illustrated in FIG. 3 includes one or more processors 70, storage 72 (which can include volatile and non-volatile memory), for the storage of programs and data. FIG. 3 illustrates that the storage 72 includes tax refund programs forming a tax refund processing module 74 and tax refund records 76. It should be noted that the storage 72 can contain other applications and data.

FIG. 3 also represents, schematically, a keyboard 78 and a display 80. The keyboard 78 can be keyboard with separate keys, or can be configured as a touch screen keyboard and can be used for the input of numerical and/or other characters as appropriate. The display 80 can be a numeric display, an alphanumeric display, an image display, etc. as appropriate to enable a tax refund system operator to view system data.

FIG. 3 further illustrates a printer 82 and a communications interface 84. The printer can be used for printing system data. The communications interface 84 enables communication via one or more communication channels 86 with the payment terminal system 10, either directly or via a retailer computer network (not shown).

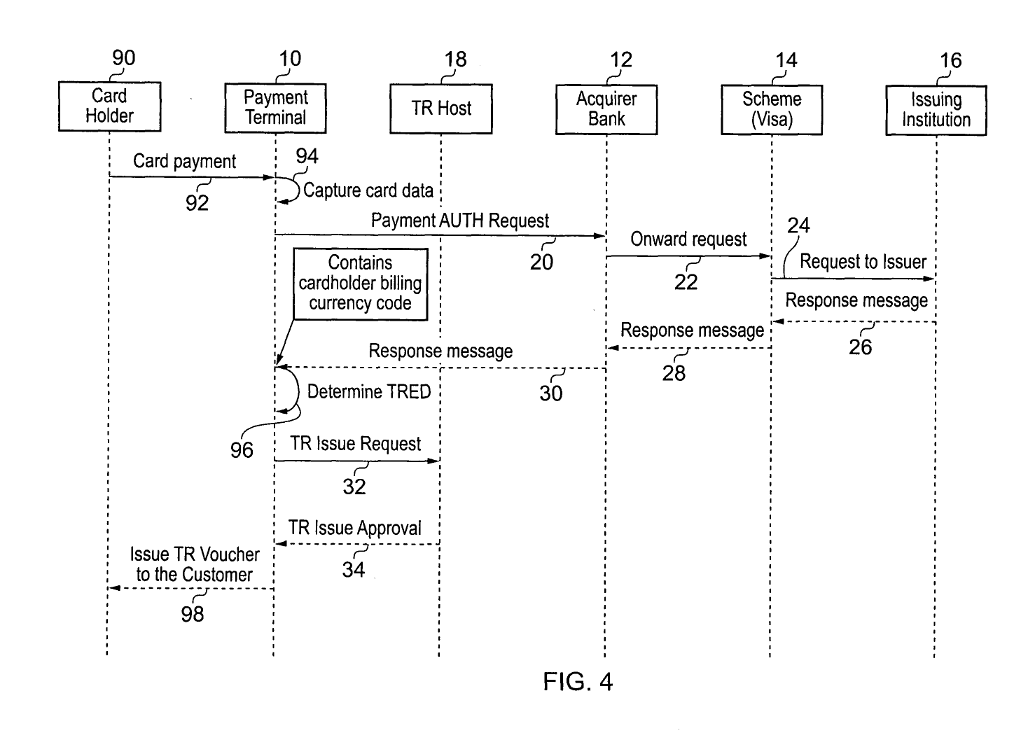

FIG. 4 is a process diagram illustrating an example of card payment and tax refund system operations for a card purchase.

A payment card holder 90 makes a payment 92 using a payment card at a payment terminal system 10.

The payment terminal system 10 then captures 94 card data from a payment card, for example using a card reader 54 (FIG. 2) using a magnetic stripe reader or chip reader. The payment terminal system 10 also captures details of the purchase to be made, for example in response to scanning a bar code or RFI tag, or in response to a retailer typing in the purchase details. The processor 40 (FIG. 2) of the payment terminal system 10 generates a payment authorisation request message 20 that is transmitted to the acquirer bank system 12 associated with the payment terminal system or a retailer operating the payment terminal system 10. The payment authorisation request message 20 includes data that identifies the captured card data, the details of the purchase including a purchase amount, and routing information identifying the payment terminal system 10. The message 20 can be sent, for example, using a conventional message protocol, for example a message packet-based protocol, for example ISO8583.

The acquirer bank system 12 receives the payment authorisation request message 20 from the payment terminal system 10 and analyses the payment authorisation request message 20 to determine an appropriate scheme network system 14 for the card concerned. This can be determined by comparing the received payment card data to tables identifying scheme network codes in the received payment card details. The acquirer bank system then forward a payment authorisation request message 22 to the appropriate scheme network system 14. The payment authorisation request message 22 can include the data of the payment authorisation request message 20 and additionally routing information identifying the acquirer bank system 12. The message 22 can be sent, for example, using a conventional message protocol, for example a message packet-based protocol, such as VISA BASE I authorisation message using a message packet-based protocol.

The scheme network system 14 receives the payment authorisation request message 22 from the acquirer bank system 12 and analyses the received payment authorisation request message 22 to identify the issuing financial institution that issued the payment card. This can be determined by comparing the received payment card data to tables identifying issuing financial institution codes in the received payment card details. In particular, for issuing financial institutions that subscribe to a multi currency service, the scheme network system 14 is operable to identify the home currency (or the billing currency) for the payment card concerned of the issuing financial institution system 16 (e.g. from the PAN), to identify an exchange rate between the local currency of the transaction terminal system 10 and home currency of the issuing financial institution system and to compute an equivalent amount in the home currency. The scheme network 14 is then operable to generate a payment authorisation request message 24 to be sent to the issuing financial institution system 16 that, in addition to some or all of the data of the payment authorisation request message 22 and additional routing information identifying the scheme network 14 also identifies the home currency of the issuing financial institution, the transaction amount converted in to the home currency by the scheme network system 14 and the exchange rate used by the scheme network system 14 in respective fields of the payment authorisation request message 24. (For example, for a scheme network system operated by VISA, the home currency, the converted transaction amount and the exchange rate are contained in fields 51, 6 and 10, respectively of the payment authorisation request message 24). The scheme network 14 is then operable to forward the payment authorisation request message to the issuing financial institution system 16 concerned. The message 22 can be sent, for example, using a conventional message protocol, for example a message packet-based protocol.

The issuing financial institution system 16 receives the payment authorisation request message 24 and processes the authorisation request by comparing the details of the payment request to records held for the payment card concerned. The issuing financial institution system 16 maintains details of the payment card account, including details of the payment card holder, a card purchase record, a credit limit, whether the account is active or blocked, a billing currency, etc. The issuing financial institution system 16 is operable to use the payment card details to confirm that the payment card is active and not blocked, and then to check that the payment can be authorised in accordance with rules appropriate for the payment card account (for example based on the amount of the transaction verses a payment history and/or an available credit, etc.). If the transaction is to be authorised, then the issuing financial institution system 16 will reserve the amount in the home currency identified in the authorisation request message against the card account and will generate an appropriate positive authorisation response message 26 to be sent to the transaction terminal system 10 using the routing information contained in the received payment authorisation request message 24. If the payment is not authorised, or a referral check is required, then an appropriate negative response message is generated instead.

The authorisation response message 26 identifies the original payment authorisation request message 20 and includes the routing information from the payment authorisation request messages 20, 22 and 24. In some, at least some, authorisation response messages 26, the issuing financial institution system will also include in the authorisation response message 26 the home currency, the converted transaction amount and the exchange rate received in the respective fields of the payment authorisation request message 24 (although in some cases these may be omitted).

The issuing financial institution system 16 returns an authorisation response message 26 to the scheme network 14 using the routing information in the payment authorisation request message 24.

The scheme network 14 receives the authorisation response message 26 and identifies routing information from the authorisation response message 24 for causing an authorisation response message 28 to be sent to the appropriate acquiring bank system 12. The authorisation response message 28 sent by the scheme network system 14 identifies the original payment authorisation request message 20 and includes routing information from the payment authorisation request messages 20 and 22. The authorisation response messages 28 can further identify the home currency, the converted transaction amount and the exchange rate of the respective fields of the payment authorisation request message 24, whether or not these were contained in the authorisation response message 26. In some cases, however, these fields may be omitted.

The acquirer bank system 12 receives the authorisation response message 28 and identifies routing information in the authorisation response message for sending an authorisation response message 30 to the transaction terminal system 10.

The authorisation request and response messages can include various fields. For example the authorisation request and/or response messages can include filed selected from, for example:
a message type identifier field defining a message type; and
a processing code field defining a transaction type and an account type;
a transaction amount filed specifying the transaction amount;
a transmission date and time field;
an expiration date field for the payment card;
a merchant category code field;
and acquiring institution country code field;
a POS entry mode code field;
a POS condition code field;
an acquiring institution identification field;
a retrieval reference number field;
an authorisation code or approval code field;
a response code field;
a card acceptor identification field;
a card acceptor name and location field;
a transaction currency code field;
a cardholder billing currency field;
an additional POS information field;
a private field.

The payment terminal system 10 is configured to analyse the authorisation response message 30 to identify if a billing currency code is identified therein. In the present example the tax refund module 46 is operable to identify 96 a billing currency code provided in the authorisation response message 30 and to compare this to one or more reference currencies 48 recorded the payment terminal system 10 storage 42.

If a billing currency code is identified in the authorisation response message that is different from reference currency code(s) 48 recorded the payment terminal system 10 storage 42, then the payment terminal system 10 is configured to identify the payment card holder as a purchaser that may be entitled to a tax refund.

Optionally, the payment terminal system 10 can be configured automatically to generate a tax refund form. For example, the PFS form can be printed using the printer 58 (FIG. 2).

Alternatively, the payment terminal system 10 can optionally be operable to generate a message on the display 56 (FIG. 2) of the payment terminal system 10 to request the retail operator or the payment card proprietor to confirm whether a tax refund form is required or not. If it is confirmed that a tax refund form is required, then the tax refund form can be printed using the printer 58 (FIG. 2).

Optionally, the tax refund module 46 of the payment terminal system 10 can be operable to send a tax refund issue request 32 to the tax refund system 18. In response to an indication that a tax refund form is required, the payment terminal system 10 can then print 98 a tax refund form.

As an alternative to printing a tax refund form, or in addition to printing a tax refund form, the card reader 54 (FIG. 2) can be configured to write tax refund form information to the payment card in the case that the card reader is also configured as a card writer, and where the payment card is configured to act as an off-line record of tax refund forms.

Alternatively, or in addition, the payment terminal system 10 can be operable to transmit electronic tax refund form information to the tax refund system 18 for an on-line system where tax refund forms are held electronically in the tax refund system 18.

The tax refund forms, whether printed, stored electronically on the payment card or stored electronically in the tax refund system server can then be used in a conventional or other manner to process a tax refund when the traveller leaves the country or territory concerned.

Although particular embodiments have been described, it will be appreciated that various modifications to the described embodiments and alternative embodiments can be envisaged.

For example, in the described embodiments, the payment terminal system detects a billing currency associated with the payment card, and compares this to a reference currency or currencies. It should be noted that in practice multiple reference currencies may be stored. For example, for a payment terminal system within the European Union, currency codes for multiple reference currencies corresponding to the currencies of all the EU states could be stored as all of the EU currencies could be considered as local currencies. Accordingly, a tax refund form would then be offered when none of those reference currencies match the billing currency.

Also, in the described example, the billing currency is transmitted to the payment terminal system and the payment terminal system compares the billing currency to the reference currency or currencies. However, in an alternative embodiment, the comparison could be made at another location, for example at the acquirer bank system 12 (FIG. 1) and then an appropriate flag (offer refund form/don't offer refund form) could be sent to the payment terminal system instead.

Further in the described example, the tax refund logic is placed on a separate host 18 (FIG. 1). However, in another embodiment, the tax refund logic could be incorporated into the payment terminal system 10.

Further in the example described, the “issuing financial institution” 16 (FIG. 1) responds to an payment authorisation request with a response that includes an indication of the billing currency for the payment card, and then this is used as the basis for the determination as to whether a tax refund form should be offered or not. However, in another embodiment, the response to the payment authorisation request could contain information about one or more of, for example: the country where the account is located; the country where the account holding bank is located; the home, or residence country of the account holder; the currency of the country where the account holding bank is located. One or more of these items of information, which could be provided instead of, or in addition to the billing currency information, could be used to determine whether to offer a tax refund form or not.

In the described example the billing currency is compared with a reference currency (or currencies) to identify if the billing currency and the reference currency or currencies are different, and thereby to deduce an eligible country (i.e. based on a negative match). As an alternative, a positive match could be employed. For example, the billing currency could be compared with a list of currencies that are entitled to a tax refund, and if a match is found, then it would be determined that the currency is eligible.

Also, rather than comparing a billing currency to one or more reference currencies, the billing currency could be used to identify a country, and then the identified country could be matched with one or lists of eligible and/or non-eligible countries.

As mentioned above, as the eligibility detection performed by the above described embodiments typically gives an operator an indication as to whether a payment card holder is eligible for a sales tax refund, the payment terminal system could be configured to either prepare a tax refund form automatically, or to prompt the operator to ask the card payment holder whether that person wishes a tax refund form to be generated.

An example of the tax refund program module 46 may be embodied in a computer program product for operating the processor 40. The computer program product may be in the form of a computer program on a carrier medium. The carrier medium could be a storage medium such as a solid state, magnetic, optical, magneto-optical or other storage medium. The carrier medium could be a transmission medium such as broadcast, telephonic, computer network, wired, wireless, electrical, electromagnetic optical or any other transmission medium.

It should be noted that the term “payment card” as used herein is used in a generic manner to describe a token or device or carrier that can used to effect a transaction based on an account associated therewith. It should be noted that the “payment card” does not need to take form of a conventional rectangular plastic credit card or the like, possible with an integrated chip integrated therein, but the “payment card”, within the meaning applied herein, may take any other form that can be operable as a credit, debit, or other form of payment token, device or carrier. For example, within the meaning of the term “payment card” as used herein, a payment system could be based on, or permit the use of mobile telephones, personal data assistants (PDAs), or other carriers of information as the “payment card”. A mobile telephone configured as a payment card can include, for example, circuitry or software having functionality equivalent to that of a chip in an chip-based payment card. Accordingly, where reference is herein to a payment card, it is to be understood that that the “payment card” can take any suitable form to be operable as a payment token, device or carrier that is configured to conduct transactions based on an account associated therewith, for example means of appropriate software and/or a mechanism for transferring information to and from a payment terminal system (for example via contacts or in a contactless manner).

Although the embodiments described above have been described in detail, numerous variations and modifications will become apparent to those skilled in the art once the above disclosure is fully appreciated. It is intended that the following claims be interpreted to include all such variations and modifications and their equivalents.

1-20. (canceled)

21. A payment terminal system, the payment terminal system configured for one or more reference currencies or countries, the payment terminal system comprising:
an input operable to receive payment card and purchase details;
a communication interface operable to transmit input payment card details to a remote system for payment approval, which remote system generates a response message;
a processor configured to offer a tax refund record for the purchase where an indicator in the response message of a currency or country associated with the payment card differs from the one or more reference currencies or countries for the payment terminal system.

22. The system of claim 21, wherein processor is operable to identify a billing currency from a billing currency code in the response message.

23. The system of claim 21, comprising storage containing information identifying the one or more reference currencies for the payment terminal system.

24. The system of claim 21, wherein the processor is operable, on identifying that a billing currency differs from a reference currency or currencies, to prompt the purchaser to confirm that a tax refund record for the purchase is required prior to generating the tax refund record.

25. The system of claim 21, wherein the input includes a payment card reader for reading payment card details from the payment card.

26. The system of claim 21, comprising a printer for printing a tax refund form contain the tax refund record.

27. The system of claim 21, comprising a payment card writer for writing the tax refund report to storage on the payment card.

28. The system of claim 21, wherein the processor is operable to transmit the tax refund record to a remote management system.

29. The system of claim 21, wherein the remote management system is operable to operable to store electronic tax refund records.

30. A tax refund system comprising a plurality of payment terminal systems and a remote management system, wherein:
each payment terminal system comprises
an input operable to receive payment card and purchase details,
a communication interface operable to transmit input payment card details to a remote system for payment approval, which remote system generates a response message,
a processor configured to offer a tax refund record for the purchase where an indicator in the response message of a currency or country associated with the payment card differs from the one or more reference currencies or countries for the payment terminal system; and
the remote management system comprising storage containing received tax refund records.

31. A method of automatically determining purchases potentially entitled to a tax refund, the method comprising:
receiving, at a payment terminal system, input of payment card and purchase details;
transmitting input payment card details to a remote system for payment approval;
the remote system generating a response message; and
offering a tax refund record for the purchase where an indicator in the response message of a currency or country associated with the payment card differs from one or more reference currencies or countries for the payment terminal system.

32. The method of claim 31, wherein a billing currency is identified from a billing currency code in the response message.

33. The method of claim 31, comprising comparing the determined billing currency for the payment card from the response message to one or more reference currencies recorded for the payment terminal.

34. The method of claim 32, comprising, on identifying that a billing currency differs from a reference currency or currencies, prompting the purchaser to confirm that a tax refund record for the purchase is required prior to generating the tax refund record.

35. The method of claim 31, comprising receiving payment card details from the payment card using a payment card reader.

36. The method of claim 31, comprising printing a tax refund form contain the tax refund record.

37. The method of claim 31, comprising writing the tax refund report to storage on the payment card.

38. The method of claim 31, comprising transmitting the tax refund record to a remote management system.

39. The method of claim 31, wherein the remote management system is operable to store electronic tax refund records.

40. The method of claim 31, further comprising refunding tax for the purchase based on the tax refund record.
